(19) United States
(12) Patent Application Publication
(10) Pub. No.: US 2024/0270880 A1
(43) Pub. Date: Aug. 15, 2024

(54) PROCESSES FOR PRODUCING AND REPROCESSING A RECYCLABLE ETHYLENE-VINYL ESTER POLYMER

(71) Applicants: BRASKEM AMERICA, INC., Philadelphia, PA (US); Case Western Reserve University, Cleveland, OH (US)

(72) Inventors: Kimberly Miller McLoughlin, Pittsburgh, PA (US); Sarah Mitchell, Pittsburgh, PA (US); Michelle Sing, Pittsburgh, PA (US); Jayme Kennedy, Pittsburgh, PA (US); Ica Manas-Zloczower, Cleveland, OH (US); Alireza Bandegi, Cleveland, OH (US); Amin Osouski, Cleveland, OH (US); Thomas Gray, Cleveland, OH (US)

(21) Appl. No.: 18/394,838

(22) Filed: Dec. 22, 2023

Related U.S. Application Data
(60) Provisional application No. 63/434,652, filed on Dec. 22, 2022.

(51) Int. Cl. C08F 8/14; B01J 31/04; C08F 210/02; C08F 218/08

(52) U.S. Cl. CPC C08F 8/14; B01J 31/04; C08F 210/02; C08F 218/08

(57) ABSTRACT

This invention relates to a process for producing a recyclable ethylene-vinyl ester polymer comprising reacting an ethylene-vinyl ester polymer having an irreversibly crosslinked structure with a poly(vinyl alcohol) (PVA), via a transesterification reaction, in the presence of a transesterification catalyst, to produce a recyclable ethylene-vinyl ester vitrimer. This invention also relates to a recyclable ethylene-vinyl ester vitrimer prepared according to the process.

### PRIORITY CLAIM

This application claims benefit of priority under 35 U.S.C. § 119(e) to U.S. Provisional Application No. 63/434,652, filed Dec. 22, 2023, which is herein incorporated by reference in its entirety.

### GOVERNMENT SUPPORT

This invention was made with government support under Advanced Manufacturing Office Award Number DE-EE0007897, awarded by the Department of Energy to the REMADE Institute, a division of Sustainable Manufacturing Alliance Corp. The government has certain rights in the invention.

### FIELD OF THE INVENTION

This invention generally relates to processes for producing and reprocessing a recyclable ethylene-vinyl ester polymer.

### BACKGROUND OF THE INVENTION

Poly (ethylene-vinyl acetate) (EVA) is a copolymer of ethylene and vinyl acetate (VA) frequently used as a commodity plastic. The properties of EVA are mainly controlled by the VA content. In most applications, EVA is used as a crosslinked material that has been cured in the presence of a free radical initiator such as peroxide to form a three-dimensional network. Crosslinked EVA materials are used in a range of applications such as insulation materials, cables, photovoltaic modules, and shoe soles. However, crosslinked EVAs cannot typically be recycled or reused due to their high thermal and chemical stability.

One way to address the challenge of EVA recyclability involves converting the permanently crosslinked network into a covalent adaptive network (CAN). In CANs, dynamic crosslinks are incorporated into a polymer network to promote an exchange reaction that leads to topology rearrangement of the polymer network. Consequently, CANs can be reprocessed similar to thermoplastic materials without loss in mechanical properties. A new class of materials, vitrimers, has recently been proposed and which involves adopting CANs in a crosslinked polyester network using a classical transesterification reaction. The efficient exchange reactions in vitrimers allow for topological rearrangement at high temperatures and result in rapid stress relaxation while preserving network integrity. Different types of vitrimers based on dynamic chemistries such as dioxaborolane metathesis, boronic ester, vinylogous urethanes, transesterification and disulfides have been developed. Each of these chemistries relax their stress under imposed strain which indicates re-processability. Most vitrimers can be reprocessed through conventional techniques for processing thermoplastic materials, such as extrusion, melt blowing, injection molding, and compression molding.

Guo, Haochen, et. al. in “Recycling poly (ethylene-vinyl acetate) with improved properties through dynamic cross-linking” (2019), developed a vitrimer-like crosslinked EVA through cross-linking thermoplastic EVA with a dynamic cross-linker (i.e., triethyl borate). The EVA vitrimer showed enhanced thermal stability and mechanical properties with up to two times enhancement in Young's modulus and storage modulus compared with the thermoplastic EVA. However, this method is typically only applicable for thermoplastic EVAs. While the presence of dynamic crosslinks enhances the properties of thermoplastic EVA while preserving processability, the triethyl borate crosslinker cannot be applied to permanently crosslinked EVA using most commercially relevant techniques.

Yue, Liang, et al. in “Vitrimerization: converting thermoset polymers into vitrimers” (2020) has shown it is possible to recycle thermoset waste by incorporating dynamic crosslinks while ball milling to produce a vitrimer. In some respects, ball milling is a more viable approach because it is more economical, environmentally friendly, and commercially scalable. The incorporation of an appropriate catalyst while ball milling a permanently crosslinked network results in the formation of metal-ligand bonds. The vitrimerization happens through compression molding of the ball milled powder at elevated temperatures which results in the formation of dynamic crosslinked network.

Despite these recent advances, there remains a continuing need in the art to develop new approaches to recycle crosslinked EVAs into high value-added products. This invention answers that need.

### SUMMARY OF THE INVENTION

In this new approach to recycle crosslinked EVAs, the inventors have focused on the presence of ester groups in the EVA networks, which allows for vitrimerization to be accomplished with transesterification catalyst. To enable a transesterification reaction, a feedstock of hydroxyl groups is added in the reacting step. Vitrimerization of crosslinked EVAs was then achieved by reacting crosslinked EVA powder, a transesterification catalyst, and poly (vinyl alcohol) (PVA) as the feedstock for hydroxyl groups.

Thus, one aspect of the invention relates to a process for producing a recyclable ethylene-vinyl ester polymer. The process comprises reacting an ethylene-vinyl ester polymer having an irreversibly crosslinked structure with a poly(vinyl alcohol) (PVA) via a transesterification reaction in the presence of a transesterification catalyst to produce a recyclable ethylene-vinyl ester vitrimer.

Another aspect of the invention relates to a recyclable ethylene-vinyl ester vitrimer. The recyclable ethylene-vinyl ester vitrimer is produced by the process described herein, i.e., a process comprising reacting an ethylene-vinyl ester polymer having an irreversibly crosslinked structure with a poly(vinyl alcohol) (PVA) via a transesterification reaction in the presence of a transesterification catalyst.

Another aspect of the invention relates to a reprocessed ethylene-vinyl ester vitrimer. The reprocessed ethylene-vinyl ester vitrimer is produced by the process for producing a recyclable ethylene-vinyl ester polymer described herein, the process further comprising processing the recyclable ethylene-vinyl ester vitrimer to form a processed profile.

### BRIEF DESCRIPTION OF DRAWINGS

FIG. 1 shows the particle size distribution of crosslinked EVA powders after cryomilling for 10, 30, and 45 minutes. Particle sizes larger than 1 mm are related to the agglomeration of some powders under microscope.

FIG. 2 shows an explanatory scheme of steps of a vitrimerization process of crosslinked EVA according to one embodiment of the present disclosure.

FIGS. 3A-3C are schemes showing steps involved in the formation of an EVA vitrimer. FIG. 3A shows the vitrimerization of cryomilled powder of crosslinked EVA and topology rearrangement within the vitrimerized network during reprocessing at elevated temperatures. FIG. 3B shows the potential zinc-complexes in the vitrimerized network. FIG. 3C shows the potential free hydroxyl groups in the vitrimerized network.

FIGS. 4A-4B show the FTIR spectra of initial crosslinked and vitrimerized EVAs. FIG. 4A shows the full FTIR spectra. FIG. 4B show the magnified spectrum range related to ester functional groups (1737 cm⁻¹) and zinc-ligand complexes (1600-1500 cm⁻¹).

FIG. 5A shows the stress relaxation of vitrimerized EVAs at different temperatures. FIG. 5B shows Arrhenius plots of the measured relaxation times.

FIG. 6 shows the stress-relaxation curves of initial crosslinked EVAs, vitrimerized EVAs with addition of catalyst or PVOH for each of EVA-1 (FIG. 6A), EVA-2 (FIG. 6B), and EVA-3 (FIG. 6C). FIG. 6D shows the stress-relaxation curves of EVA-3 at 120° C. on five separate samples. The G₀ is considered as initial stress at time equal to one second (t=1s). The mol % of catalyst is with respect to VA.

FIG. 7 shows an explanatory scheme of steps of reprocessing of vitrimerized EVA through extrusion and compression molding.

FIG. 8 shows the unsuccessful reprocessing of compression molded EVA powders without the addition of catalyst and PVOH (FIG. 8A) and with the addition of PVOH but without the addition of catalyst (FIG. 8B).

FIGS. 9A-9C shows DMA results for the initial cross linked and vitrimerized EVAs. FIG. 6A shows DMA results for EVA-1. FIG. 6B shows DMA results for EVA-2. FIG. 6C shows DMA results for EVA-3.

FIG. 10 shows optimized geometries for the isopropyl-acetate complex. FIG. 10A shows a five-coordinate ester complex. FIG. 10B shows that a hydrogen-bonded alcohol complex where alcohol complexes to zinc. FIG. 10C shows transition state leading indicating a proton transfer prior to forming a tetrahedral carbon. FIG. 10D shows a hemiketal complex (tetrahedral intermediate). FIG. 10E shows the step-by-step formation of a hemiketal complex.

FIG. 11 shows optimized geometries for the methyl-acetate complex. FIG. 11A shows a five-coordinate ester complex. FIG. 11B shows a hydrogen-bonded alcohol complex where alcohol complexes to zinc. FIG. 11C shows transition state leading indicating a proton transfer prior to forming tetrahedral carbon. FIG. 11D shows a hemiketal complex (tetrahedral intermediate). FIG. 11E shows step-by-step formation of a hemiketal complex.

FIG. 12A shows a partial Kohn-Sham orbital energy level diagram of a five-coordinate zinc acetate complex with methyl acetate. FIG. 12B is a depiction of the LUMO. The contour level is 0.02 a.u. Percentages are of orbital density.

FIG. 13A shows a partial Kohn-Sham orbital energy level diagram of the hemiketal zinc complex formed with methanol and methyl acetate. FIG. 13B is a depiction of frontier orbitals. Contour level 0.02 a.u. Percentages are of orbital density.

### DETAILED DESCRIPTION OF THE INVENTION

### Process for Producing a Recyclable Ethylene-Vinyl Ester Polymer

In a first aspect, the present disclosure provides a novel process for producing a recyclable ethylene-vinyl ester polymer. For instance, the novel process involves reacting an ethylene-vinyl ester polymer having an irreversibly crosslinked structure with a poly(vinyl alcohol) (PVA), via a transesterification reaction in the presence of a transesterification catalyst, to produce a recyclable ethylene-vinyl ester vitrimer.

### The Polymer and the Monomer

In some embodiments, the ethylene-vinyl ester polymer is obtained from a recycled material. Suitable recycled materials include post-consumer resin (PCR), post-industrial resin (PIR), or combinations thereof.

Suitable vinyl ester monomers in the ethylene-vinyl ester polymer include an aliphatic vinyl ester having 3 to 20 carbon atoms (such as 3-10 carbon atoms, 3-8 carbon atoms, or 3-6 carbon atoms) or an aromatic vinyl ester.

In some embodiments, the ethylene-vinyl ester polymer may be an ethylene-vinyl acetate (EVA) copolymer or an ethylene-vinyl acetate-vinyl versatate terpolymer. In a particular embodiment, the ethylene-vinyl ester polymer is an ethylene-vinyl acetate (EVA) copolymer.

In one or more embodiments, the molar ratio of hydroxyl groups in the PVA to vinyl acetate (VA) in the EVA copolymer ranges from about 1 to about 5. For instance, the molar ratio of hydroxyl groups in the PVA to vinyl acetate (VA) in the EVA copolymer may range from about 1 to about 2.

### The Transesterification Catalyst

Suitable transesterification catalysts include, but are not limited to, zinc salt catalysts and transitional metal catalysts. In some embodiments, the transesterification catalyst is a zinc salt catalyst. In some embodiments, the transesterification catalyst is a transitional metal acetate catalyst. In some embodiments, the transesterification catalyst is zinc acetate.

Suitable amounts of transesterification catalyst according to the present disclosure range from about 0.1 mol % to about 20 mol %, relative to 100 mol % of the vinyl acetate (VA) content in the EVA copolymer. In some embodiments, the amount of transesterification catalyst ranges from about 1 mol % to about 20 mol %, or about 2 mol % to about 15 mol %, or about 3 to about 15 mol %, or about 5 mol % to about 10 mol %, relative to 100 mol % of the VA content in the EVA copolymer. In some embodiments, the transesterification catalyst is zinc acetate.

### The Reacting Step

The reacting step of the process may include a grinding step that involves grinding the EVA polymer, PVA, and the transesterification catalyst into fine powders.

In some embodiments, the reacting step is carried out at a temperature ranging from 120 to 200° C., for example from 150 to 200° C., or from 160 to 190° C., or from 170 to 180° C., or about 175° C. Suitable pressures for carrying out the reacting step ranges from about 2 MPa to about 10 MPa, for example from about 5 MPa to about 9 MPa, or about 6 MPa to about 8 MPa, or about 7 MPa.

In some embodiments, the fine powders resulted from the grinding step have a particle size of less than about 200 m, for example less than about 150 m, or less than about 100 m.

In some embodiments, the grinding step involves cryomilling. The step of cryomilling may be carried out for about 40 to 50 minutes and/or at a frequency of about 25 to 35 Hz.

### Product and Further Processing

In some embodiments, the recyclable ethylene-vinyl ester vitrimer produced according to the process of the present disclosure contains a covalent adaptive network formed by dynamic, reversibly crosslinked structure that allows the recyclable ethylene vinyl ester vitrimer to be reprocessed at a temperature of 120° C. or higher, such as 130° C. or higher, 140° C. or higher, or 150° C. or higher.

In some embodiments, the produced recyclable ethylene-vinyl ester vitrimer can be reprocessed at a temperature of 120° C. or higher at least one, at least two, or at least three times, without adding further reactants and/or catalysts.

The process for producing a recyclable ethylene-vinyl ester polymer may comprise further steps. For instance, in one or more embodiments, the process for producing a recyclable ethylene-vinyl ester polymer described herein may further include the step of processing the recyclable ethylene-vinyl ester vitrimer to form a processed profile. In some embodiments, the processing step comprises extrusion, melt blowing, molding, or combinations thereof. In some embodiments, the processing step comprises extruding the recyclable ethylene-vinyl ester vitrimer at a temperature of about 120° C. or higher, for example about 140° C. or higher, about 160° C. or higher, or about 175° C. or higher.

### The Recyclable Ethylene-Vinyl Ester Polymer

In another aspect, the present disclosure relates to a recyclable ethylene-vinyl ester vitrimer, prepared according to the process for producing a recyclable ethylene-vinyl ester polymer described herein.

The produced recyclable ethylene-vinyl ester vitrimer may exhibit a decreased crystallinity of about 10% or more, the crystallinity X % calculated by Equation 1 (Eq. 1) below:

$$X \% = \frac{Δ {H}_{f}}{( {x}_{P E} \times Δ {H}_{0} )} , \qquad ( Eq . 1 )$$

wherein ΔH_{f}, x_{PE} and ΔH₀ are the melting enthalpy (kJ/mol), the fraction of polyethylene in each grade (no unit), and the melting enthalpy of a perfect polyethylene crystal (kJ/mol), respectively, each measured by differential scanning calorimetry (DSC).

In some embodiments, the recyclable ethylene-vinyl ester vitrimer may exhibit a decreased crystallinity of about 25% or more, such as 30% or more, 40% or more, or 50% or more.

The recyclable ethylene-vinyl ester vitrimer may exhibit an increased solvent-swelling ratio, characterizing a lower crosslinking density, of about 1.5 fold or more (such as about 1.75 or more, about 2.0 or more, or about 2.5 or more), the solvent swelling ratio calculated by Equation 2 (Eq. 2) below:

$$Swelling ratio ( \% ) = \frac{{W}_{s w e l l e d} - {W}_{d r y}}{{W}_{d r y}} \times 100 , \qquad ( Eq . 2 )$$

wherein W_{swelled} and W_{dry} are the masses of the swelled and dry polymer, respectively, measured in toluene at 100° C.

In some embodiments, the recyclable ethylene-vinyl ester vitrimer may exhibit an increased solvent swelling ratio of about 2.5 fold or more.

The recyclable ethylene vinyl ester vitrimer disclosed herein may exhibit an increased tensile modulus (Young's modulus) of about 100% or more, for instance of about 125% or more, about 150% or more, about 175% or more, or about 200% or more.

### Reprocessed Ethylene-Vinyl Ester Polymer

The process for producing a recyclable ethylene-vinyl ester polymer may comprise the further step of processing the recyclable ethylene-vinyl ester vitrimer to form a processed profile. In this context, another aspect the present disclosure relates to a reprocessed ethylene-vinyl ester vitrimer prepared according to such further processing step.

In some embodiments, the processing may be carried out at a temperature of 120° C. or higher at least one, at least two or at least three times, without adding further reactants and/or catalysts. In some embodiments, the processing step comprises extrusion, melt blowing, molding, or combinations thereof. In some embodiments, the processing step comprises extruding the recyclable ethylene-vinyl ester vitrimer at a temperature of about 120° C. or higher, for example, about 150° C. or higher, about 175° C. or higher, or about 200° C. or higher.

### EXAMPLES

The following examples are for illustrative purposes only and are not intended to limit, in any way, the scope of the present invention.

### Materials and Methods

### Materials

All three EVA grades EVA-1, EVA-2 and EVA-3 were supplied by Braskem. PVOH, zinc acetate, and dicumyl peroxide (DCP) were purchased from Sigma-Aldrich and used as received.

### Compounding and Crosslinking

A micro-compounder (Xplore) was used to mix dicumyl peroxide (DCP) with EVA granules. The temperature zones of the micro-compounder were held constant at 100° C., i.e., close to melting temperature of EVA grades. The screw speed was 30 rpm and the die port was held open. Each extrudate strand was collected, chopped to sizes of 3 to 5 mm, and fed to the micro-compounder for a second pass. All EVA/DCP blends were crosslinked using compression molding (Carver press) at 175° C. for 15 minutes under constant pressure of 1 MPa. The molds were 1 mm thick. Molar feed ratios ([VA]/[DCP]) are reported in Table 1.

TABLE 1
Properties of EVA materials selected for vitrimerization and amount of
transesterification catalyst and PVOH used for vitrimerization of EVAs.

| | | Nominal MFR^{a} | | | | |
|---|---|---|---|---|---|---|
| | | (ASTM D1238 | | | | |
| | | @ 190° C./ | Mw^{b} | [VA]/ | | Zinc |
| | wt % VA | 2.16 kg) | (GPC) | [DCP] | PVOH | acetate |
| Sample | (1H-NMR) | g/10 min | (g/mol) | (mol/mol) | (wt %) | (wt %) |
| EVA-1 | 19 | 8.0 | 83,679 | 30 ± 0.03 | 12.3 | 2.5 |
| EVA-2 | 22 | 2.1 | 103,591 | 35 ± 0.03 | 14.1 | 2.9 |
| EVA-3 | 9 | 2.0 | 100,604 | 14 ± 0.07 | 6.5 | 1.4 |

^{a}melt flow rate from datasheet (measured according to ASTM D1238 @ 190° C./2.16 kg)
^{b}molecular weight of initial thermoplastic EVAs

¹H-NMR spectroscopy: 200 mg of EVA copolymer was diluted in 75% ODCB+25% TCE-d (vol). The sample was heated to 150° C. until solution was homogeneous. NMR was performed on a Bruker 500 MHz spectrometer at 120° C. The spectra was acquired using the following variables/settings: autolock, autoshim, zg30 pulse sequence, 32 scans, 12.5 sec relaxation delay, and 2.5 sec acquisition time. The following peaks were used to determine VA content: PE (CH2) peak: 1.53 ppm and VA (CH) peak: 5.13 ppm.

Gel permeation chromatography (GPC): The GPC experiments were carried out in a gel permeation chromatography coupled with triple detection, with an infrared detector IR5 and a four bridge capillary viscometer, both from PolymerChar and an eight angle light scattering detector from Wyatt. A set of 4 column, mixed bed, 13 pm from Tosoh in a temperature of 140° C. was used. The conditions of the experiments were: concentration of 1 mg/mL, flow rate of 1 mL/min, dissolution temperature and time of 160° C. and 90 minutes, respectively, and an injection volume of 200 pL. The solvent used was TCB (Trichloro benzene) stabilized with 100 ppm of BHT. The molecular weight was determined via universal calibration from the viscometer detector.

### Vitrimization Process

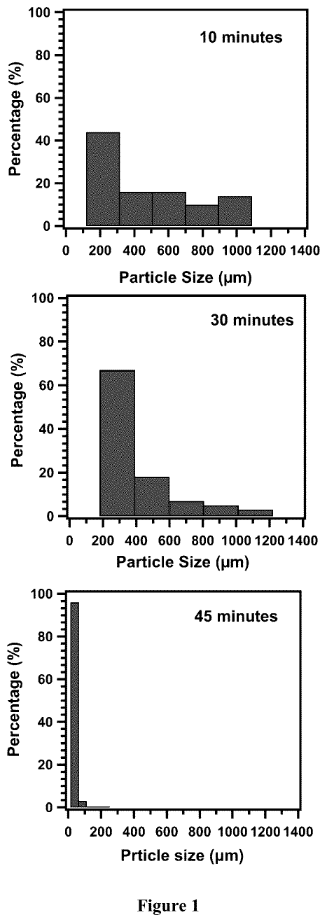

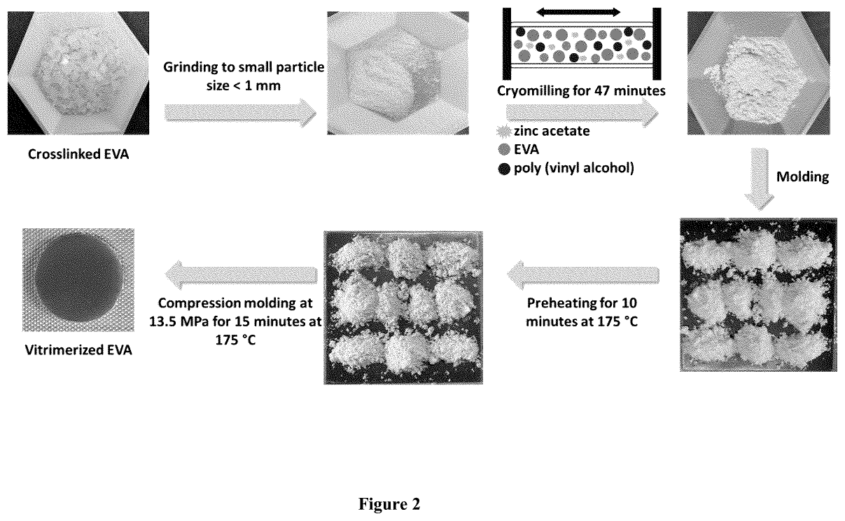

Cryomilled powders (<200 μm) were obtained by cryomilling fine EVA particles (<1 mm) with catalyst (zinc acetate) and PVOH in a cryomill tank (Retsch Cryomill), purged with N₂ (g). Each cryomilling process was 47 minutes with 3 cycles of grinding for 15 minutes at a frequency of 30 Hz and 2 intermediate grindings for 1 minute at frequency of 5 Hz. The cryomilled powders did not contain any large particle and showed a narrow size distribution of fine powders (<200 μm) (FIG. 1). Compression molding of the cryomilled powder mixtures (1.5 to 2 grams) was performed at 175° C. and 13.5 MPa with 10 minutes preheating and 15 minutes heating and applying pressure in the mold (area of 4.9 cm² and thickness of 1 mm), to obtain the vitrimerized samples. A flow chart representative of the vitrimization process is provided in FIG. 2.

### Reprocessing Procedure

The compression molded vitrimerized samples were cut into small pieces of 3 to 5 mm and then extruded using a counter-rotating minilab twin screw extruder operating at 120° C. and screw speed of 10 rpm with a residence time of 3 minutes. Then, the extruded strands were cut into small pieces of 3 to 5 mm, weighting 0.5 gram and compression molded (area of 4.9 cm² and thickness of 1 mm) at 175° C. for 15 minutes at 13.5 MPa. These samples were cut again into small pieces (3 to 5 mm) and compression molded again under the same processing conditions.

### Characterization

Dynamic Mechanical Analysis (DMA): The dynamic mechanical properties were measured by TA Instruments Q800. The tensile mode with a strain amplitude of 0.5% and constant frequency of 1 Hz was used for the measurement. Temperature was increased with a scanning rate of 5° C. min⁻¹ from −55 to 200° C.

Fourier Transform Infrared Spectroscopy (FTIR): FTIR analyses were carried out in a spectral range of 4000-600 cm⁻¹ using an Agilent Cary 630 FTIR spectrophotometer.

Rheology: TA ARES-G2 rheometer with a 25 mm parallel plate geometry was used to measure stress relaxation. The samples with an average thickness of 1.2 mm were equilibrated for 10 minutes at the desired temperature and then a 1% strain was applied. To avoid the gap between the sample and geometry, a constant normal force of 10 N was applied during the test.

Solvent Swelling: Crosslinked polymers were placed in vials with solvent. The vials were kept in an oil bath at temperature of 100° C. The samples were removed from the vials, surface-dried, and weighed daily until the mass at equilibrium swelling was reached. The samples were then removed from the solvent, allowed to dry completely under vacuum at 60° C. for five days and then weighed to determine the mass of the dry crosslinked polymer. The swelling ratio was obtained from Equation 3 (Eq. 3) below:

$$Swelling ratio ( \% ) = \frac{{W}_{s w e l l e d} - {W}_{d r y}}{{W}_{d r y}} \times 100 \qquad ( Eq . 3 )$$

### Calculations

Spin-restricted density-functional theory computations were performed within Gaussian16 rev. A.03. Calculations utilized the PBE0 exchange-correlation functional of Perdew, Burke, and Ernzerhof (J. P. Perdew, K. Burke and M. Ernzerhof, Generalized Gradient Approximation Made Simple, Phys. Rev. Lett., 1996), and the def2tzvp basis set (F. Weigend and R. Ahlrichs, Balanced Basis Sets of Split Valence, Triple Zeta Valence and Quadruple Zeta Valence Quality for H to Rn: Design and Assessment of Accuracy, Phys. Chem. Chem. Phys., 2005; and F. Weigend, Accurate Coulomb-Fitting Basis Sets for H to Rn, Phys. Chem. Chem. Phys., 2006). Optimizations proceeded using tight convergence criteria and an ultrafine integration grid. Harmonic vibrational frequencies confirmed stationary points as minima or saddle points of the potential energy hypersurface. All calculations include Grimme's empirical dispersion correction with Becke-Johnson damping (S. Grimme, S. Ehrlich and L. Goerigk, Effect of the Damping Function in Dispersion Corrected Density Functional Theory, J. Comput. Chem., 2011). Standard Mulliken and Mayer population analyses were performed with the AOMix-CDA program of Gorelsky (S. I. Gorelsky, AOMix: Program for Molecular Orbital Analysis, University of Ottawa, version 6.94, 2018; and S. I. Gorelsky and A. B. P. Lever, J. Organomet. Chem., 2001, 635, 187-196).

### Example A—Formation of EVA Vitrimer

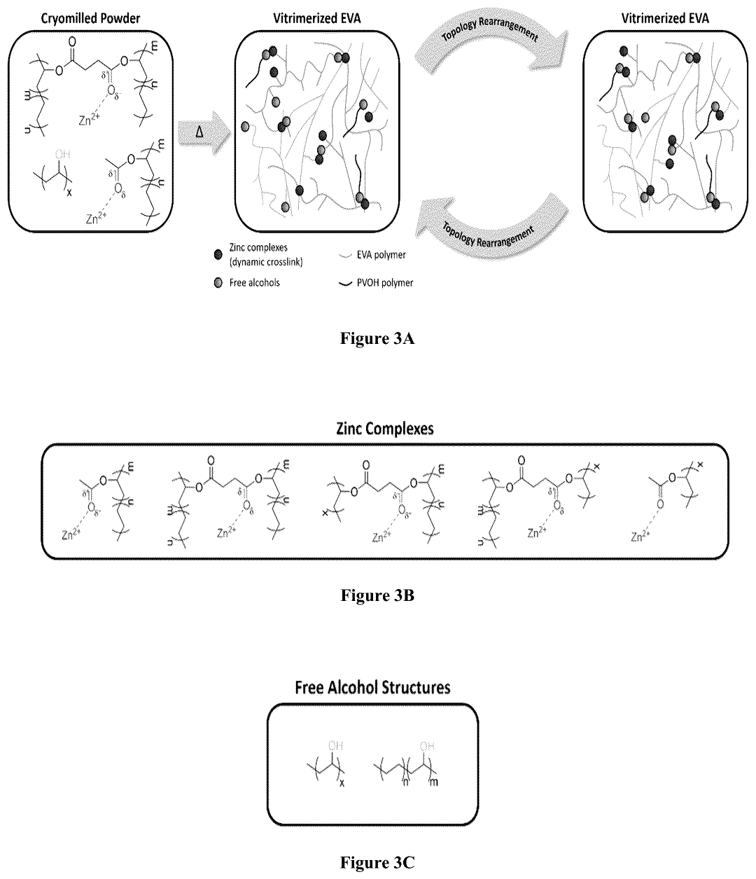

The vitrimerization process was performed with three different crosslinked EVAs with varying VA content and molecular weight as per the values described in Table 1 (EVA-1, EVA-2, and EVA-3), a transesterification catalyst, and feedstock hydroxy groups. To initiate vitrimerization, the dynamic crosslinks were installed into the crosslinked EVA network through cryomilling crosslinked EVAs with the transesterification catalyst and feedstock hydroxy groups. For each vitrimerization, the concentration of transesterification catalyst (zinc acetate) was kept constant, with 8 mol % zinc acetate respective to the VA content. The concentration of feedstock hydroxy groups (PVOH) was also kept constant with a 1.5 molar ratio of hydroxyl groups to VA groups ([OH]/[VA]=1.5). During cryomilling, zinc atoms from the zinc acetate coordinate to VA groups throughout the crosslinked EVA networks to form ester-zinc complexes (FIG. 3A). These complexes served as dynamic crosslink sites throughout the crosslinked network and would undergo a transesterification reaction at high temperatures with hydroxy groups from PVOH.

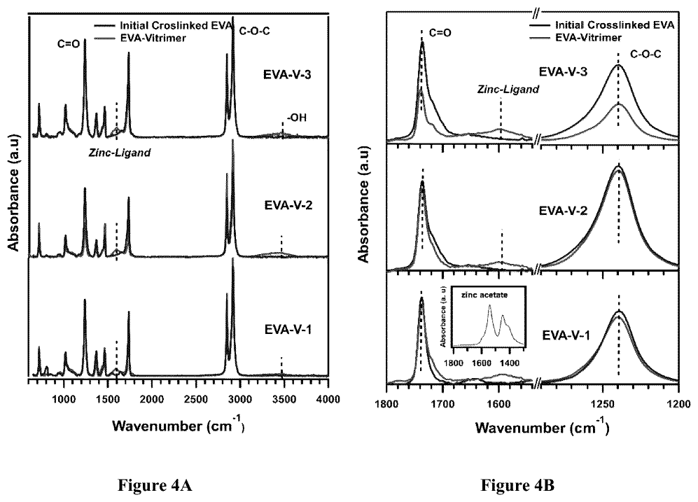

FTIR was used to confirm the formation of ester-zinc complexes and the presence of feedstock hydroxy groups (FIG. 4A). In the initially crosslinked EVA spectra, no peak was observed related to hydroxyl groups (3200 to 3600 cm⁻¹), indicating that a source of hydroxy groups via PVOH could be added. The peak related to ester-zinc complex was observed to appears at 1600-1500 cm⁻¹ with low and broad intensity relative to the ester functional groups (FIG. 4B). This peak was present in each of the three EVA vitrimer spectra, whereas as no peak was present for the initially crosslinked EVA samples. This indicates the formation of ester-zinc complexes throughout the network after cryomilling.

Once cryomilling occurs and dynamic crosslinks were inserted throughout the crosslinked network, a transesterification reaction was initiated via compression molding the cryomilled powders. The transesterification reaction was observed to occur between ester-zinc complexes and free hydroxy groups present in the system (FIG. 3). Since zinc acetate can complex to both free and crosslinked VA groups, both types of ester-zinc complexes can contribute to the transesterification reactions during the vitrimerization process resulting in a complex vitrimerized network. After the first processing cycle of the vitrimerized network, the systems consisted of a complex mixture of ester-zinc complexes and free hydroxyl groups (FIGS. 3B and 3C). This indicated that topology rearrangement of vitrimerized EVA therefore occurred through a combination of exchange reactions between any ester and hydroxyl group present in the system at elevated temperatures during compression molding.

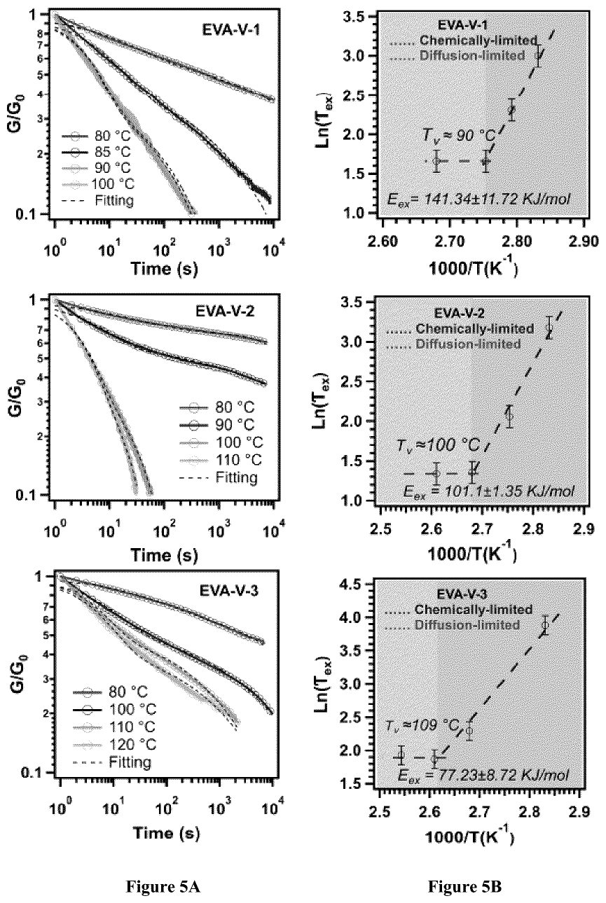

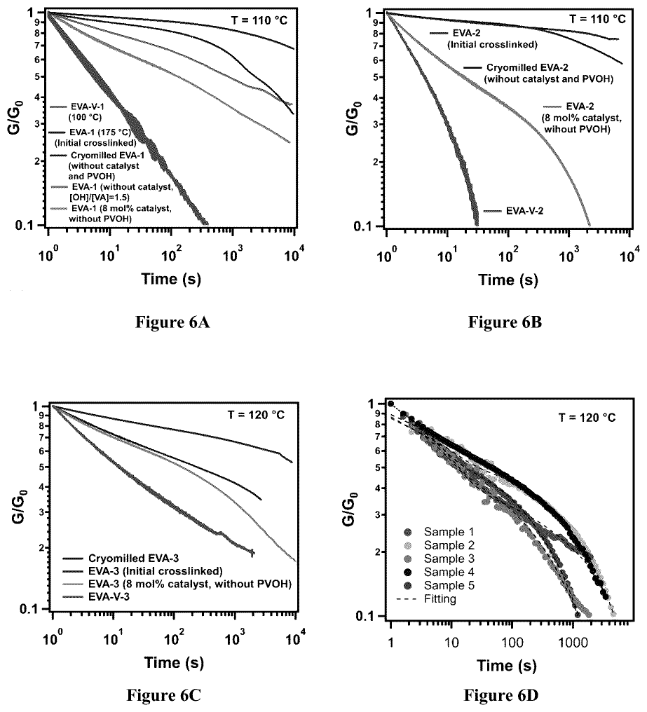

To confirm the formation of a vitrimer network, stress relaxation for each of the vitrimerized EVAs was obtained (FIG. 5A). Characteristic of a vitrimer network, exchange reactions are activated at high temperatures leading to topology rearrangements and stress relaxation. Each vitrimerized EVA exhibited stress relaxation at different starting temperatures. For comparison, the stress relaxation of the initial crosslinked EVAs, EVAs cryomilled without catalyst, EVAs cryomilled without PVOH, and EVAs cryomilled without catalyst and PVOH were measured. Each of these control samples exhibited slower relaxation rates compared to the vitrimerized EVAs (FIG. 6). The stress relaxation results confirm that the crosslinked EVA networks were successfully vitrimerized and bond exchange reactions occurred within the crosslinked networks.

In most studies on vitrimer systems, a characteristic relaxation time, i*(T), is obtained from a simple Maxwell model and is considered as the time required to relax the stress to 1/e of its initial value. In the present disclosure, due to the sharp transition at the initial stage of stress relaxation, a single exponential decay cannot describe quantitatively the stress relaxation of the vitrimerized networks. L. Imbernon et al. in “Stress Relaxation and Self-Adhesion of Rubbers with Exchangeable Links”, Macromolecules (2016) and M. Hayashi and L. Chen in “Functionalization of Triblock Copolymer Elastomers by Cross-Linking the End Blocks via Trans-N-Alkylation-Based Exchangeable Bonds”, Polym. Chem. (2020) have demonstrated that for more complex vitrimer systems, stress relaxation can be deconvoluted into two characteristic times: a long time corresponding to the network relaxation (“net”) and a short time corresponding to the bond exchange reaction (“ex”). Given the commercial scale of the starting materials and their resultant dispersity, it also fits that the characteristic relaxation times would reflect a distribution of times and thus the relaxation behavior should follow a Kohlrausch-Williams-Watts (KWW) stretched exponential decay, as shown in Equation 4 (Eq. 4) below:

$$\frac{σ ( t )}{{σ}_{0}} = [ {A}_{net} exp \{ - {( t / {τ}_{net} )}^{{β}_{net}} \} + {A}_{ex} exp \{ - {( t / {τ}_{ex} )}^{{β}_{ex}} \} ] \qquad ( Eq . 4 )$$

where σ(t)/σ₀ is the normalized stress at time t, r is the characteristic relaxation time (seconds), A is the contribution of two relaxation components such that Aₙₑₜ+Aₑₓ=1, and β is the exponent which controls the shape of the stretched exponential decay.

Deviations of β from unity reflect a broad distribution of relaxation times, such that the smaller the value of β the broader the distribution. Given the quality of the fits of Equation 4 to the vitrimers disclosed herein, it is reasonable to assume that the hypothesized relationship between the long and short relaxation times holds for these materials. The fitting parameters obtained from equation 4 are listed in Tables 2 to 5.

TABLE 2
Parameters obtained from fitting stress relaxation curves to experimental data for EVA-1 using equation 4.

| Temperature | τₙₑₜ | τₑₓ | | | | | Adjusted |
|---|---|---|---|---|---|---|---|
| (° C.) | (seconds) | (seconds) | βₙₑₜ | βₑₓ | Aₙₑₜ | Aₑₓ | R² |
| 80 | 73594 ± 337 | 20.0 ± 0.05 | 0.33 ± 0.00 | 0.48 ± 0.00 | 0.61 ± 0.00 | 0.39 ± 0.00 | 0.9926 |
| 85 | 1360 ± 34 | 10.0 ± 0.03 | 0.30 ± 0.00 | 0.70 ± 0.00 | 0.53 ± 0.00 | 0.47 ± 0.00 | 0.9924 |
| 90 | 113 ± 3 | 5.0 ± 0.02 | 0.41 ± 0.00 | 0.97 ± 0.01 | 0.46 ± 0.00 | 0.54 ± 0.01 | 0.9903 |
| 100 | 123 ± 5 | 5.0 ± 0.23 | 0.40 ± 0.01 | 0.90 ± 0.01 | 0.47 ± 0.00 | 0.53 ± 0.01 | 0.9878 |

TABLE 3
Parameters obtained from fitting stress relaxation curves to experimental data for EVA-2 using equation 4.

| Temperature | τₙₑₜ | τₑₓ | | | | | Adjusted |
|---|---|---|---|---|---|---|---|
| (° C.) | (seconds) | (seconds) | βₙₑₜ | βₑₓ | Aₙₑₜ | Aₑₓ | R² |
| 80 | 50870 ± 20956 | 24.59 ± 0.03 | 0.99 ± 0.00 | 0.44 ± 0.00 | 0.69 ± 0.00 | 0.31 ± 0.00 | 0.9963 |
| 90 | 85061 ± 605 | 7.80 ± 0.02 | 0.24 ± 0.00 | 0.72 ± 0.00 | 0.62 ± 0.00 | 0.38 ± 0.00 | 0.9903 |
| 100 | 42 ± 0 | 3.87 ± 0.01 | 0.81 ± 0.01 | 1.00 ± 0.01 | 0.39 ± 0.00 | 0.62 ± 0.01 | 0.9968 |
| 110 | 27 ± 0 | 3.80 ± 0.01 | 1.00 ± 0.01 | 1.00 ± 0.01 | 0.36 ± 0.00 | 0.64 ± 0.05 | 0.9860 |

TABLE 4
Parameters obtained from fitting stress relaxation curves to experimental data for EVA-3 using equation 4.

| Temperature | τₙₑₜ | τₑₓ | | | | | Adjusted |
|---|---|---|---|---|---|---|---|
| (° C.) | (seconds) | (seconds) | βₙₑₜ | βₑₓ | Aₙₑₜ | Aₑₓ | R² |
| 80 | 53007 ± 383 | 48.35 ± 0.07 | 0.37 ± 0.01 | 0.47 ± 0.00 | 0.71 ± 0.00 | 0.29 ± 0.01 | 0.9959 |
| 100 | 6766 ± 77 | 9.87 ± 0.02 | 0.29 ± 0.00 | 0.71 ± 0.00 | 0.60 ± 0.00 | 0.40 ± 0.00 | 0.9940 |
| 110 | 1114 ± 15 | 6.48 ± 0.02 | 0.33 ± 0.00 | 0.88 ± 0.00 | 0.59 ± 0.00 | 0.41 ± 0.00 | 0.9927 |
| 120 | 1546 ± 42 | 6.87 ± 0.02 | 0.32 ± 0.00 | 0.78 ± 0.01 | 0.49 ± 0.00 | 0.51 ± 0.00 | 0.9880 |

TABLE 5
Parameters obtained from fitting stress relaxation curves to experimental
data (repeated for five times) measured at 120° C. for EVA-3.

| Temperature | τₙₑₜ | τₑₓ | | | | | Adjusted |
|---|---|---|---|---|---|---|---|
| (° C.) | (seconds) | (seconds) | βₙₑₜ | βₑₓ | Aₙₑₜ | Aₑₓ | R² |
| 120 | 297 ± 2 | 4.87 ± 0.01 | 0.43 ± 0.00 | 1.00 ± 0.01 | 0.65 ± 0.00 | 0.35 ± 0.00 | 0.9969 |
| 120 | 270 ± 6 | 6.71 ± 0.02 | 0.39 ± 0.00 | 1.00 ± 0.01 | 0.61 ± 0.00 | 0.39 ± 0.00 | 0.9809 |
| 120 | 1445 ± 10 | 4.98 ± 0.02 | 0.46 ± 0.00 | 0.73 ± 0.01 | 0.57 ± 0.00 | 0.43 ± 0.00 | 0.9814 |
| 120 | 1546 ± 42 | 6.87 ± 0.02 | 0.32 ± 0.00 | 0.78 ± 0.01 | 0.49 ± 0.00 | 0.51 ± 0.00 | 0.9880 |
| 120 | 713 ± 4 | 5.90 ± 0.01 | 0.37 ± 0.00 | 1.00 ± 0.00 | 0.72 ± 0.00 | 0.28 ± 0.00 | 0.9970 |

The characteristic relaxation times for the bond exchange reaction at different temperatures are plotted using the Arrhenius relationship, shown in Equation 5 (Eq. 5):

$${τ}^{*} ( T ) = {τ}_{0}^{*} ( T ) exp ( {E}_{e x} / RT ) \qquad ( Eq . 5 )$$

Here τ*(T) is the characteristic relaxation time determined from fits to the stress relaxation data following equation 4, where τ*(T) corresponds to τₑₓ at the test temperature (seconds), Eₑₓ is the activation energy, R is the universal gas constant, and T is the absolute temperature (K). The Arrhenius plots in FIG. 5B show two distinct regions—one where the characteristic relaxation time appears to be independent of temperature, and one where the characteristic relaxation time is a function of temperature. This behavior suggests that there is another mechanism besides the transesterification reaction which contributes to the stress-relaxation of the vitrimerized samples, such as the dynamic rearrangement of polymer chains within the network. The transition between the temperature-dependent and temperature-independent regions can be attributed to the vitrification temperature (Tv), the temperature above which a dynamic exchange reaction occurs rapidly and along experimentally relevant time scales. On the Arrhenius plots in FIG. 5B, the Tv demarcates two distinct regions: a chemically limited regime (dark gray) corresponding to the transesterification reaction, and a diffusion-limited regime (light gray) in which chain diffusion constitutes a rate limiting step.

The activation energy values obtained from the slope in the chemically limited regime (dashed line) for the vitrimerized EVA samples are consistent with values reported in literature (70 to 150 kJ/mol-T. Kimura and M. Hayashi, One-Shot Transformation of Ordinary Polyesters into Vitrimers: Decomposition-Triggered) for the activation energy of transesterification bond exchange reactions.

### Example B—Reprocessing Vitrimerized EVAs

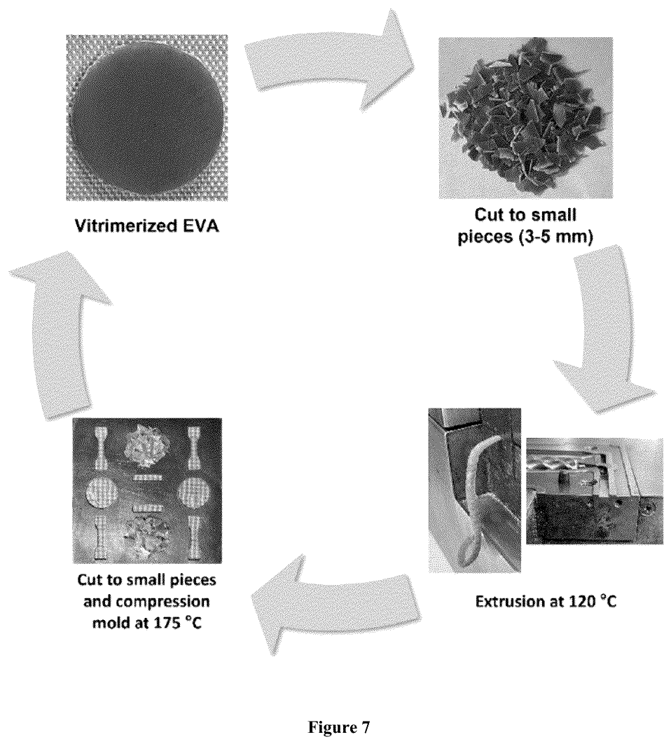

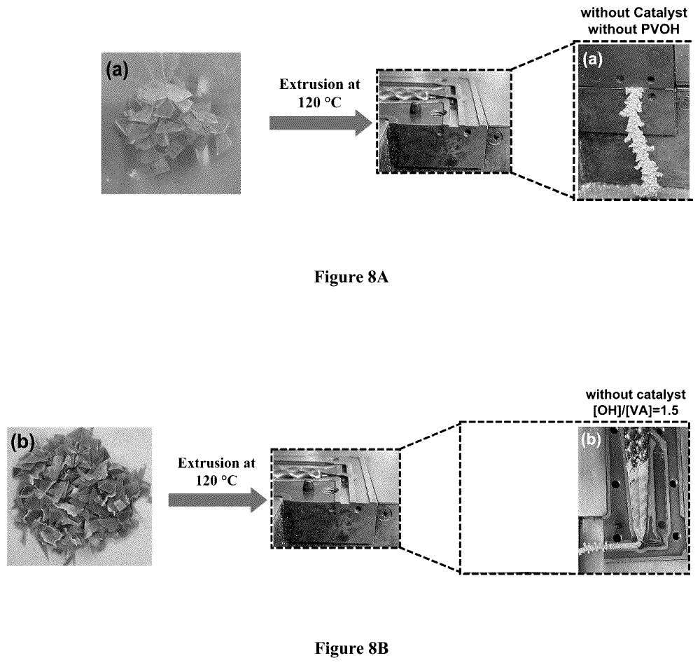

With the confirmation of vitrimerized samples via FTIR and stress relaxation, the re-processability of the vitrimerized EVAs was explored using extrusion and compression molding, both conventional techniques for processing thermoplastic materials (FIG. 7). Subsequent reprocessing steps was performed without the addition of extra catalyst or PVOH at temperatures as low as 120° C., which is in line with the vitrimerization temperatures determined via stress relaxation (in the range of 90-110° C.). To further confirm the need for both the zinc acetate catalyst and PVOH feedstock to vitrimerize crosslinked EVA, samples were cryomilled with different combinations of feedstock and catalyst. Samples cryomilled with just feedstock PVOH (no catalyst) were not re-processable via extrusion and did not retain a network structure (FIG. 8). Samples with only zinc acetate (no PVOH) could also not be reprocessed and high temperature solvent swelling resulted in the material dissolving, indicating that a vitrimerized network was not formed.

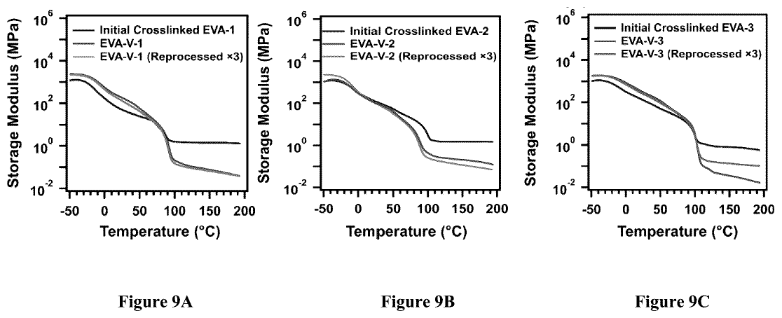

DMA results confirm that the vitrimerized and reprocessed samples exhibit the elastic properties of crosslinked networks indicated by the presence of a high temperature rubbery plateau (FIG. 9). However, the vitrimerized and reprocessed samples showed lower rubbery plateau moduli compared to initial crosslinked EVAs, indicative of a lower crosslinking density in the polymer network. This lower crosslinking density is confirmed via solvent swelling experiments at high temperature (100° C.), where the vitrimerized and reprocessed samples exhibited a higher swelling ratio relative to initial crosslinked EVAs, as shown in Table 6.

TABLE 6
Swelling ratio of initial crosslinked and
vitrimerized EVAs in toluene and water.

| | | | | EVA- | EVA- | EVA- |
|---|---|---|---|---|---|---|
| Solvent | EVA1 | EVA2 | EVA3 | V-1 | V-2 | V-3 |
| Toluene | 504 | 569 | 347 | 1901 | 2080 | 980 |
| (100° C.) | | | | | | |
| Water | 4 | 25 | 26 | 50 | 42 | 70 |
| (100° C.) | | | | | | |
| Water | 2 | 11 | 24 | 6 | 13 | 40 |
| (25° C.) | | | | | | |

At room temperature, the reprocessed samples maintained or even exceeded the storage modulus of the initially vitrimerized EVAs (FIG. 9). K. M. McLoughlin, et. al in “Thermomechanical Properties of Cross-Linked EVA: A Holistic Approach”, ACS Appl. Polym. Mater (2023) have shown that room temperature mechanical properties of EVA are driven by crystallinity and rigid amorphous contributions. Retention of the room temperature storage modulus indicated the retention of the integrity of the crystalline and amorphous regions after vitrimerization and reprocessing.

### Example C—Computational Results

To further develop and model the vitrimerization of crosslinked EVA via cryomilling, DFT calculations were performed using mononuclear zinc acetates as minimal models of Zn²⁺ embedded in EVA polymer networks. Zinc(II) is a closed-shell d¹⁰ metal ion with no attendant ligand-field stabilization energy and is a borderline hard-soft Lewis acid that polarizes bound carbonyl ligands. Due to zinc(II) being essentially redox-inert, it cannot inherently generate radicals (radicals that could form during cryomilled). For the simplicity of modeling purposes, primary alcohols were modeled as methanol (pKa in water is 15.5) and secondary alcohols as isopropyl alcohol (pKa in water is 16.5). The secondary alcohol model was a better comparison to the experimental vitrimerization process due to PVOH being in a secondary alcohol. The corresponding esters were modeled as methyl acetate and isopropyl acetate, allowing for degenerate exchange, which occurred in vitrimers where the reaction coordinate is identical in the forward and reverse directions.

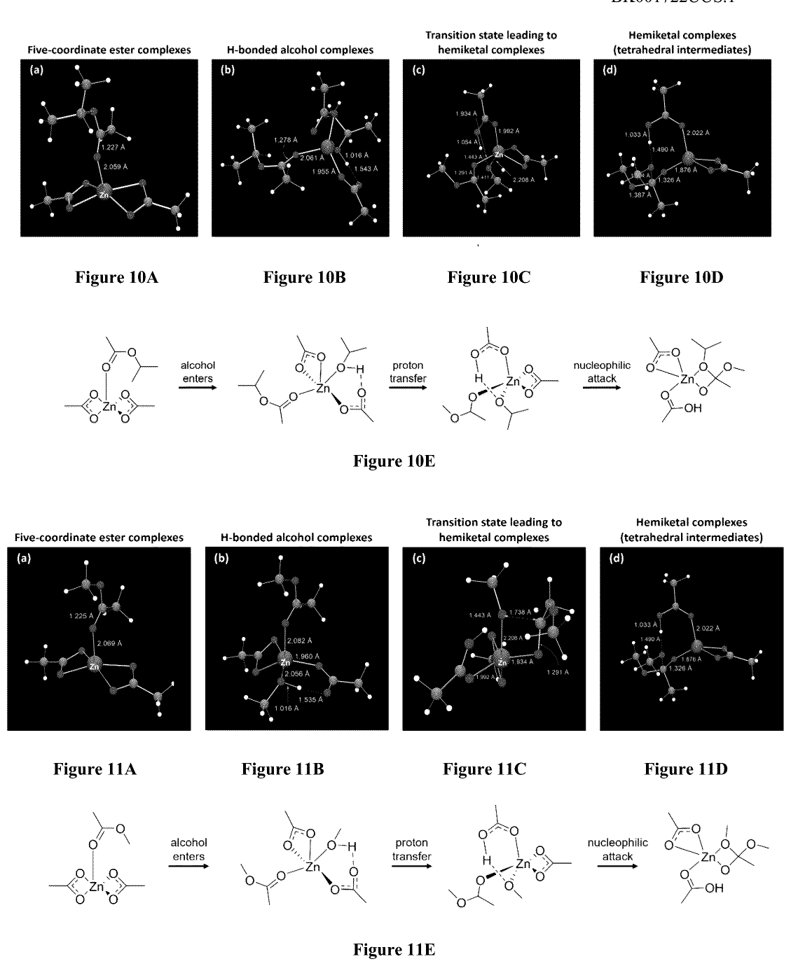

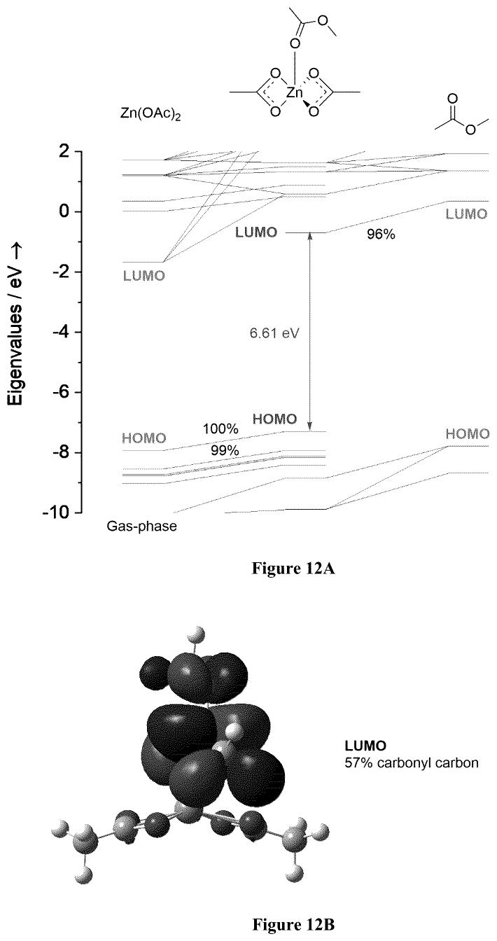

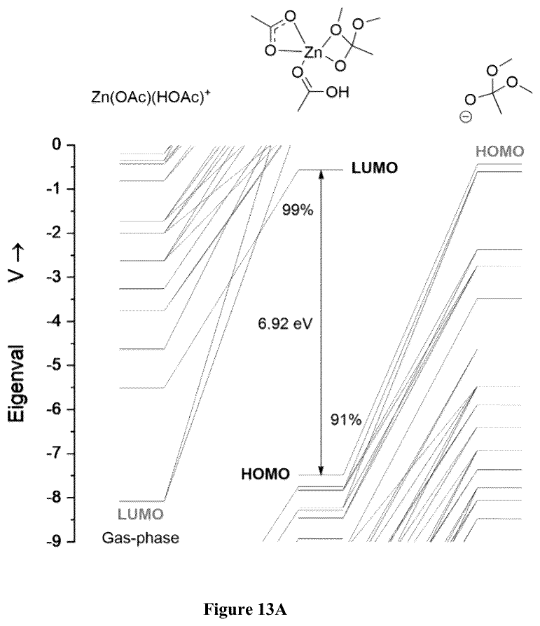

In the vitrimerization process, cryomilling was used to initially install zinc acetate into the crosslinked EVA by zinc acetate binding with VA groups present in the polymer network. To computationally observe this structure, zinc was modeled as five-coordinate zinc, where zinc binds the acetate group through the respective carbonyl oxygen in the optimized structure, FIG. 10A (isopropyl acetate) and FIG. 11A (methyl acetate). The coordination geometry of zinc is essentially square pyramidal, with both acetate counterions binding bidentately. Shown in FIG. 12 is a partial Kohn-Sham orbital energy level diagram of the five-coordinate methyl acetate complex, which indicates a high degree of electrostatic interaction between zinc and the ester ligand, with occupied orbitals originating on the zinc acetate fragment. The lowest unoccupied Kohn-Sham orbital (LUMO) resides almost entirely on the bound methyl acetate, with 57% of orbital density on the carbonyl carbon. This orbital composition is consistent with the expected electrophilicity at carbon of a bound ester. The natural atomic charge of the carbonyl carbon is +0.82 for the isopropyl acetate complex and +0.83 for the methyl acetate complex.

The cryomilled powder also includes PVOH (feedstock of hydroxy groups), so attempts to locate a six-coordinate complex where the alcohol and ester simultaneously bind zinc were attempted. The optimized geometries led to the alcohol decomplexing along with one oxygen of one acetate ligand, resulting in κ¹-acetate accepting a hydrogen bond from the alcohol ligand, FIG. 10B (isopropyl acetate) and FIG. 12 (methyl acetate).

The best model of the cryomilled powder consists of a zinc complex where zinc is five-coordinate, with three oxygen donors provided by acetates, one from the ester carbonyl, and one from the bound alcohol. The hydrogen-bonded proton of the isopropyl alcohol complex shows a Mayer bond order with the acetate oxygen (H-bond acceptor) of 0.21; the bond order to the alcohol oxygen is 0.84; further indicating that the Brønsted acidic alcohol is not dissociated. Corresponding bond orders in the methyl alcohol complex are 0.21 (H-acetate O) and 0.71 (H-alcohol O). Formation of the hydrogen bond little to no change in the electrophilicity of the ester carbonyl carbon. Natural atomic charges are 0.85 for the isopropyl alcohol complex and 0.82 for the methanol complex.

To model the second part of the vitrimerization process, where transesterification occurs via compression molding, transition states for nucleophilic attack of the bound alcohol to the bound ester were located by synchronous transit-guided quasi-Newton methods, as proposed by C. Peng and H. Bernhard Schlegel in “Combining Synchronous Transit and Quasi-Newton Methods to Find Transition States”, Isr. J. Chem. (1993). Harmonic vibrational frequency calculations validated that the converged structures are saddle points of the potential energy hypersurface. Optimized transition state geometries for the isopropyl complex appear as FIG. 10C and FIG. 12C for the methyl complex. The structure show that formation of the hemiketal entails proton transfer from the alcohol oxygen to the dangling (K1) carboxylate. The nucleophilic (alcohol) oxygen enters within bonding range of the ester carbon, which pyramidalizes. The transition state lies 78.7 kJ/mol above the separated reactants for the isopropyl ester and 97.9 kJ/mol methyl ester, in terms of free energy (activation energy).

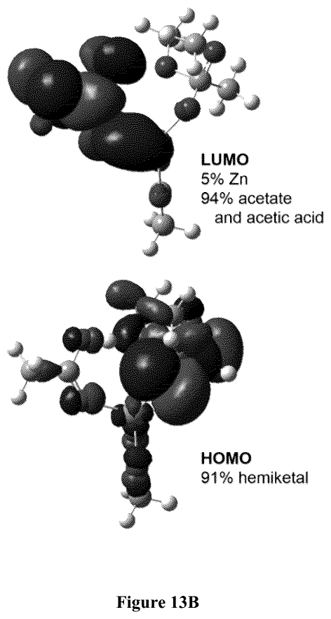

Formation of the hemiketal (tetrahedral carbon) occurs once the proton transfer to the K1 acetate is complete and nucleophilic attack of the alcohol oxygen to the ester carbon occurs. The tetrahedral carbon binds as a chelating anion toward zinc and the coordination geometry is best described as distorted square pyramidal. Converged geometries of hemiketal complexes appear as FIG. 10D for the isopropyl complex and FIG. 12D for the methyl complex. FIG. 13 depicts a partial Kohn-Sham orbital energy level diagram of the hemiketal complex formed from methanol and methyl acetate. The diagram suggests strong electrostatic bonding, with frontier orbitals tightly localized on the hemiketal (HOMO) or κ²-acetate; there is little mixing between them. The HOMO now resides on the (anionic) hemiketal, as expected for a nucleophile; and the LUMO resides on the more electrophilic κ2-acetate, with minimal density on zinc. This result complements the need for supporting basic sites in catalyzed transesterifications. Additionally, the methodology developed herein confirm the mechanism for vitrimer formation in crosslinked EVAs using a zinc acetate catalyst and PVOH feedstock.

### Conclusion

A series of permanently crosslinked EVAs with different VA content and a range of molecular weights were vitrimerized via cryomilling crosslinked EVA with zinc acetate and PVOH. The vitrimerized EVAs relaxed stress rapidly at temperatures as low as 100° C. and were therefore re-processable through conventional processing methods for thermoplastic polymers such as extrusion and compression molding at temperatures as low as 120° C. The vitrimerized samples could be reprocessed at least three times without additional catalyst or feedstock hydroxy groups. It was found that, in the vitrimerization process, the addition of zinc acetate and PVOH can assist in the transesterification reaction.

DFT calculations support the need for the —OH feedstock and indicate approximate activation free energies of 78.7 kJ/mol for zinc acetate-mediated transesterification of secondary alcohols. Formation of the tetrahedral intermediate occurs via proton transfer followed by nucleophilic attack of the alcohol oxygen to the ester carbon. The presence of hydrogen bonds with the acetate groups indicate that the carboxylate ligands are not passive in the transesterification reaction.

What is claimed:

1. A process for producing a recyclable ethylene-vinyl ester polymer, comprising:
reacting (a) an ethylene-vinyl ester polymer having an irreversibly crosslinked structure with (b) a poly(vinyl alcohol) (PVA), via a transesterification reaction, in the presence of a transesterification catalyst, to produce a recyclable ethylene-vinyl ester vitrimer.

2. The process of claim 1, wherein the ethylene-vinyl ester polymer is obtained from a recycled material.

3. The process of claim 2, wherein the recycled material is a post-consumer resin (PCR), post-industrial resin (PIR), or combinations thereof.

4. The process of claim 1, wherein the vinyl ester in the ethylene-vinyl ester polymer is an aliphatic vinyl ester having 3 to 20 carbon atoms or an aromatic vinyl ester.

5. The process of claim 4, wherein the ethylene-vinyl ester polymer is an ethylene-vinyl acetate (EVA) copolymer or an ethylene-vinyl acetate-vinyl versatate terpolymer.

6. The process of claim 5, wherein the ethylene-vinyl ester polymer is an ethylene-vinyl acetate (EVA) copolymer.

7. The process of claim 6, wherein the transesterification catalyst is a zinc salt catalyst.

8. The process of claim 6, wherein the transesterification catalyst is a transitional metal acetate catalyst.

9. The process of claim 6, wherein the transesterification catalyst is zinc acetate.

10. The process of claim 9, wherein the amount of zinc acetate ranges from about 0.1 mol % to about 20 mol %, relative to 100 mol % of the vinyl acetate (VA) content in the EVA copolymer.

11. The process of claim 10, wherein the amount of zinc acetate ranges from about 5 mol % to about 10 mol %, relative to 100 mol % of the VA content in the EVA copolymer.

12. The process of claim 6, wherein the molar ratio of hydroxyl groups in the PVA to vinyl acetate (VA) in the EVA copolymer ranges from about 1 to about 5.

13. The process of claim 12, wherein the molar ratio of hydroxyl groups in the PVA to VA in the EVA copolymer ranges from about 1 to about 2.

14. The process of claim 6, wherein the reacting step comprises grinding the EVA polymer, PVA, and the transesterification catalyst into fine powders.

15. The process of claim 14, wherein the grinding step involves cryomilling, and the fine powders have a particle size of less than 200 m.

16. The process of claim 15, wherein the cryomilling is carried out for about 40-50 minutes, at a frequency of about 25-35 Hz.

17. The process of claim 6, wherein the reacting step is carried out at a temperature ranging from 120-200° C.

18. The process of claim 17, wherein the reacting step is carried out at a temperature ranging from 170-180° C.

19. The process of claim 6, wherein the reacting step is carried out at a pressure ranging from 2 MPa to 10 MPa.

20. The process of claim 6, wherein the reacting step is carried out at a temperature at about 175° C. and a pressure at about 7 MPa.

21. The process of claim 1, wherein the produced recyclable ethylene-vinyl ester vitrimer contains a covalent adaptive network formed by dynamic, reversibly crosslinked structure that allows the recyclable ethylene vinyl ester vitrimer to be reprocessed at a temperature of 120° C. or higher.

22. The process of claim 22, wherein the produced recyclable ethylene-vinyl ester vitrimer can be reprocessed at a temperature of 120° C. or higher at least three times, without adding further reactants and/or catalysts.

23. The process of claim 1, further comprising:
processing the recyclable ethylene-vinyl ester vitrimer to form a processed profile.

24. The process of claim 23, wherein the processing step comprises extrusion, melt blowing, molding, or combinations thereof.

25. The process of claim 24, wherein the processing step comprises extruding the recyclable ethylene-vinyl ester vitrimer at a temperature of 120° C. or higher.

26. The process of claim 24, wherein the processing step comprises compression molding the recyclable ethylene-vinyl ester vitrimer at a temperature of 175° C. or higher.

27. A recyclable ethylene-vinyl ester vitrimer, prepared according to the process of claim 1.

28. The recyclable ethylene vinyl ester vitrimer of claim 27, wherein the produced recyclable ethylene-vinyl ester vitrimer exhibits a decreased crystallinity of about 10% or more, the crystallinity X % calculated by
$$X \% = \frac{Δ {H}_{f}}{( {x}_{P E} \times Δ {H}_{0} )} ,$$
wherein ΔH_{f}, x_{PE} and ΔH₀ are the melting enthalpy, the fraction of polyethylene in each grade, and the melting enthalpy of a perfect polyethylene crystal, respectively, measured by differential scanning calorimetry (DSC).

29. The recyclable ethylene vinyl ester vitrimer of claim 28, wherein the produced recyclable ethylene-vinyl ester vitrimer exhibits a decreased crystallinity of about 25% or more.

30. The recyclable ethylene vinyl ester vitrimer of claim 27, wherein the produced recyclable ethylene-vinyl ester vitrimer exhibits an increased solvent-swelling ratio characterizing a lower crosslinking density, of about 1.5 fold or more, the solvent swelling ratio calculated by
$$Swelling ratio ( \% ) = \frac{{W}_{s w e l l e d} - {W}_{d r y}}{{W}_{d r y}} \times 100 ,$$
wherein W_{swelled} and W_{dry} are the masses of the swelled and dry polymer, respectively, measured in toluene at 100° C.

31. The recyclable ethylene vinyl ester vitrimer of claim 30, wherein the produced recyclable ethylene-vinyl ester vitrimer exhibits an increased solvent swelling ratio of about 2.5 fold or more.

32. The recyclable ethylene vinyl ester vitrimer of claim 27, wherein the produced recyclable ethylene-vinyl ester vitrimer exhibits an increased tensile modulus (Young's modulus) of about 100% or more.

33. The recyclable ethylene vinyl ester vitrimer of claim 32, wherein the produced recyclable ethylene-vinyl ester vitrimer exhibits an increased tensile modulus (Young's modulus) of about 150% or more.

34. A reprocessed ethylene-vinyl ester vitrimer, prepared according to the process of claim 23.
